(19) United States
(12) Patent Application Publication
(10) Pub. No.: US 2013/0145340 A1
(43) Pub. Date: Jun. 6, 2013

(54) Determination Of Uniform Colorability Of Layout Data For A Double Patterning Manufacturing Process

(71) Applicant: Qiao Li, Lake Oswego, OR (US)

(72) Inventor: Qiao Li, Lake Oswego, OR (US)

(21) Appl. No.: 13/536,955

(22) Filed: Jun. 28, 2012

Related U.S. Application Data
(60) Provisional application No. 61/502,330, filed on Jun. 28, 2011.

(51) Int. Cl. G06F 17/50

(52) U.S. Cl. CPC G06F 17/5045
USPC 716/136; 716/106

(57) ABSTRACT

Graph structures are obtained corresponding to geometric elements in the lowest hierarchical level of cells in a design of hierarchical layout data. Each graph structure then is analyzed for conflicts that would preclude an error-free partitioning of the represented geometric elements into two complementary sets. If there are no conflicts, then relevant portions of each graph structure are promoted into the corresponding parent cells of the next highest hierarchical level of the hierarchical layout design. This process of obtaining graph structures for cells of a hierarchical level, checking the graph structures to determine if they have conflicts, and promoting relevant portions of the graph structures to the graph structures for the next hierarchical level is iteratively repeated for each level in the hierarchical layout design, until a conflict is detected or until it is determined that no conflicts exist for the graph structure corresponding to the highest level cell.

### RELATED APPLICATIONS

This application claims priority under 35 U.S.C. §1.19 to U.S. Patent Application No. 61/502,330, entitled “Determination Of Uniform Colorability Of Layout Data For A Double Patterning Manufacturing Process,” filed Jun. 28, 2011, and naming Qiao Li as inventor, which provisional patent application is incorporated entirely herein by reference.

### FIELD OF THE INVENTION

The present invention is directed the determination of whether a set of electronic circuit layout data can be uniformly colored. Various implementations of the invention may be particularly useful for determining whether a multiple occurrences of a cell of layout design data can be uniformly colored in the same manner throughout a larger set of layout design data for manufacture using a double patterning lithographic process.

### BACKGROUND

Microdevices, such as integrated microcircuits and microelectromechanical systems (MEMS), are used in a variety of products, from automobiles to microwaves to personal computers. Designing and fabricating microdevices typically involves many steps, known as a “design flow.” The particular steps of a design flow often are dependent upon the type of microcircuit, its complexity, the design team, and the microdevice fabricator or foundry that will manufacture the microcircuit. Typically, software and hardware “tools” verify the design at various stages of the design flow by running software simulators and/or hardware emulators, and errors in the design are corrected or the design is otherwise improved.

Several steps are common to most design flows for integrated microcircuits. Initially, the specification for a new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools), such as Mentor Graphics' IC Station or Cadence's Virtuoso, are commonly used for both of these tasks.

With a layout design, each physical layer of the circuit, will have a corresponding layer representation in the design, and the geometric elements described in a layer representation will define the relative locations of the circuit device components that will make up a circuit device. Thus, the geometric elements in the representation of an implant layer will define the doped regions, while the geometric elements in the representation of a metal layer will define the locations in a metal layer where conductive wires will be formed to connect the circuit devices. In addition to integrated circuit microdevices, layout design data also is used to manufacture other types of microdevices, such as microelectromechanical systems (MEMS). Typically, a designer will perform a number of analyses on the layout design data. For example, with integrated circuits, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

In particular, the design flow process may include one or more resolution enhancement technique (RET) processes. These processes will modify the layout design data, to improve the usable resolution of the reticle or mask created from the design in a photolithographic manufacturing process. One such family of resolution enhancement technique (RET) processes, sometimes referred to as optical proximity correction (OPC) processes, may add features such as serifs or indentations to existing layout design data in order to compensate for diffractive effects during a lithographic manufacturing process. For example, an optical proximity correction process may modify a polygon in a layout design to include a “hammerhead” shape, in order to decrease rounding of the photolithographic image at the corners of the polygon.

After the layout design has been finalized, it is converted into a format that can be employed by a mask or reticle writing tool to create a mask or reticle for use in a photolithographic manufacturing process. The written masks or reticles then can be used in a photolithographic process to expose selected areas of a wafer to light or other radiation in order to produce the desired integrated microdevice structures on the wafer.

To meet the demand for more powerful microdevices, designers have regularly increased the average density of structures in conventional microdevices. For example, the area of an integrated circuit that might once have contained 100 transistors may now be required to contain 1,000 or even 10,000 transistors. Some current microdevice designs call for microdevice structures to be packed so closely that it may be difficult to properly manufacture adjacent structures in a single lithographic process. For example, a current microcircuit design may specify a series of parallel conductive lines positioned so closely that a conventional mask writer cannot resolve the pitch between the lines.

To address this issue, the structures in a layer of a microcircuit device are now sometimes formed using two or more separate lithographic processes. This technique, referred to as “double patterning,” partitions the geometric elements in a layout data design into two or more groups or “colors,” each of which is then used to form a complementary lithographic mask pattern. Thus, if a layout design calls for a series of closely-spaced parallel connective lines, this target pattern may be partitioned so that adjacent lines are actually formed by different masks in separate lithographic processes.

While double patterning lithographic techniques allow for denser microdevice structures, it is sometimes difficult to implement these techniques. For example, it may be difficult to determine when the geometric elements described in layout design data (corresponding to the physical structures of the microdevice) can be correctly partitioned into two complementary sets of layout design data without creating a conflict. Further, it is sometimes desirable for a reoccurring pattern of geometric elements to be consistently assigned to the same complementary set of layout design data and described in a single mask. It can be difficult, however, to determine whether every occurrence of such a pattern actually can be consistently assigned to the same complementary set of layout design data without creating a conflict somewhere in the design.

### BRIEF DESCRIPTION OF THE DRAWINGS

FIGS. 1 and 2 show components of an illustrative computing system that may be used to implement various embodiments of the invention.

### DETAILED DESCRIPTION OF THE DRAWINGS

### Uniform Colorability of a Hierarchical Design

Aspects of the invention relate to mechanisms for determining whether the geometric elements in a hierarchical layout design can be partitioned into two complementary set of layout design data without creating a conflict. According to various implementations of the invention, graph structures are obtained corresponding to the geometric elements in the lowest hierarchical level of cells in a design of hierarchical layout data. More particularly, the graph structures represent the positional information of the geometric elements in a cell.

As will be appreciated by those of ordinary skill in the art, because a “double patterning” technique typically is employed to ensure a minimum separation between adjacent structures in a microdevice layer, the proximity relationships between the corresponding pieces of the target pattern in the layout design data may be used to define the partition. For example, a user may specify that pairs of edges in the target pattern of a layout design must be imaged by different masks. This “separation directive” is then employed to partition the target pattern so that two new target patterns are created that conform to the constraints given by the separation directive. Accordingly, the graph structures also represent the separation directive or “coloring” relationship between the geometric elements represented in the graph.

Once the graph structures have been obtained, each graph structure then is analyzed for conflicts that would preclude an error-free partitioning of the represented geometric elements into two complementary sets. As will also be appreciated by those of ordinary skill in the art, a conflict, will occur when a first, geometric element has separation directives that require it to be formed on a separate mask from second and third geometric elements, and the second and third geometric elements have a separation directive that requires them to be formed on separate masks. This situation will be represented in a graph structure by, for example, a graph node corresponding to a relevant geometric element sharing two differing coloring relationships with a second graph node in the graph structure representing another geometric element.

If there are no conflicts, then relevant portions of each graph structure are promoted into the corresponding parent cells of the next highest hierarchical level of the hierarchical layout design. As will be appreciated by those of ordinary skill in the art, relevant portions of the graph structure will be those corresponding to geometric elements within a cell that are geographically close to geometric elements outside of the cell, such that there may be separation directives between them.

Graph structures then are obtained corresponding to the geometric elements in each cell of this next hierarchical level. As previously described, a graph structure represents the positional information of the geometric elements in its corresponding cell, and the separation directive or “coloring” relationship between those geometric elements. In addition, the graph structure will include the relevant portions promoted from the graph structure of a lower-level child cell. Each graph structure is then analyzed for conflicts that would preclude an error-free partitioning of the represented geometric elements into two complementary sets.

This process of obtaining graph structures for cells of a hierarchical level, checking the graph structures to determine if they have conflicts, and promoting relevant portions of the graph structures to the graph structures for the next hierarchical level is iteratively repeated for each level in the hierarchical layout design, until a conflict is detected or until it is determined that no conflicts exist for the graph structure corresponding to the highest level cell in the hierarchical layout design. If no conflicts exist for the graph structure corresponding to the highest level cell in the hierarchical layout design, then the design can be partitioned into two complementary sets of layout design data without violating a required separation directive.

### Designation of a Common Uniform Coloring Scheme

Still other embodiments of the invention allow geometric elements in layout design data to be grouped together, so that each placement of the geometric elements in the design will have the same partition assignments for a double patterning lithographic manufacturing process. For example, according to various implementations of the invention, a user can create a cell or identify an existing cell in a layout design. The user can then designate that the cell be uniformly portioned or “colored” for each placement of the cell in the layout design. With various embodiments of the invention, the designation may be in the form of, for example, a flag or other data value associated with the cell. Alternately or additionally, various embodiments of the invention may allow a user to designate that a cell be uniformly colored by specifying that characteristic in a separate data file that is processed when the geometric elements in the layout design are being assigned to a complementary set of layout design data for a double patterning lithographic manufacturing process.

### Determination of the Viability of a Common Uniform Coloring Scheme

Still other embodiments of the invention may determine whether each occurrence of a target cell in a hierarchical layout design can be uniformly colored in the same manner for partitioning into complementary sets of layout design data for a double patterning lithographic manufacturing process. With various embodiments of the invention, the target cell may be analyzed using the techniques described above to confirm that the geometric elements within the target cell can be partitioned for a double-patterning lithographic manufacturing process without conflicts. The target cell may, for example, be treated as the highest level “top” hierarchical cell with regard to the mechanisms described above.

Next, graph structures are obtained corresponding to relevant geometric elements in the target cell. As will be appreciated by those of ordinary skill in the art, if the geometric elements of the target cell can be partitioned without conflict, only the interactions with geometric elements outside of the target cell can cause the colorings of individual target cell placements to differ. Moreover, only those geometric elements located near the edge of the target cell boundary will potentially interact with geometric elements outside of the target cell. Accordingly, the graph structures represent the positional information of the geometric elements along the boundary of the target cell, and the separation directive or “coloring” relationship between those relevant geometric elements, if any.

Next, a graph structure is obtained that incorporates the graph structure of the target cell, and that also incorporates the positional information of the geometric elements and the separation directive or “coloring” relationships between those geometric elements in each parent cell of the next highest hierarchical level in which the target cell will be placed. Thus, the graph structure simultaneously represents the coloring relationship for each parent cell of the next highest hierarchical level in which the target cell will be placed. This graph structure is analyzed to identify any conflicts, i.e., a situation where a graph node corresponding to a relevant geometric element shares two differing coloring relationships with a second graph node representing another geometric element represented in the graph structure. This process is repeated for the next highest hierarchical cell level, until a conflict is detected or until the highest hierarchical cell in the design is analyzed without conflicts.

### Illustrative Operating Environment

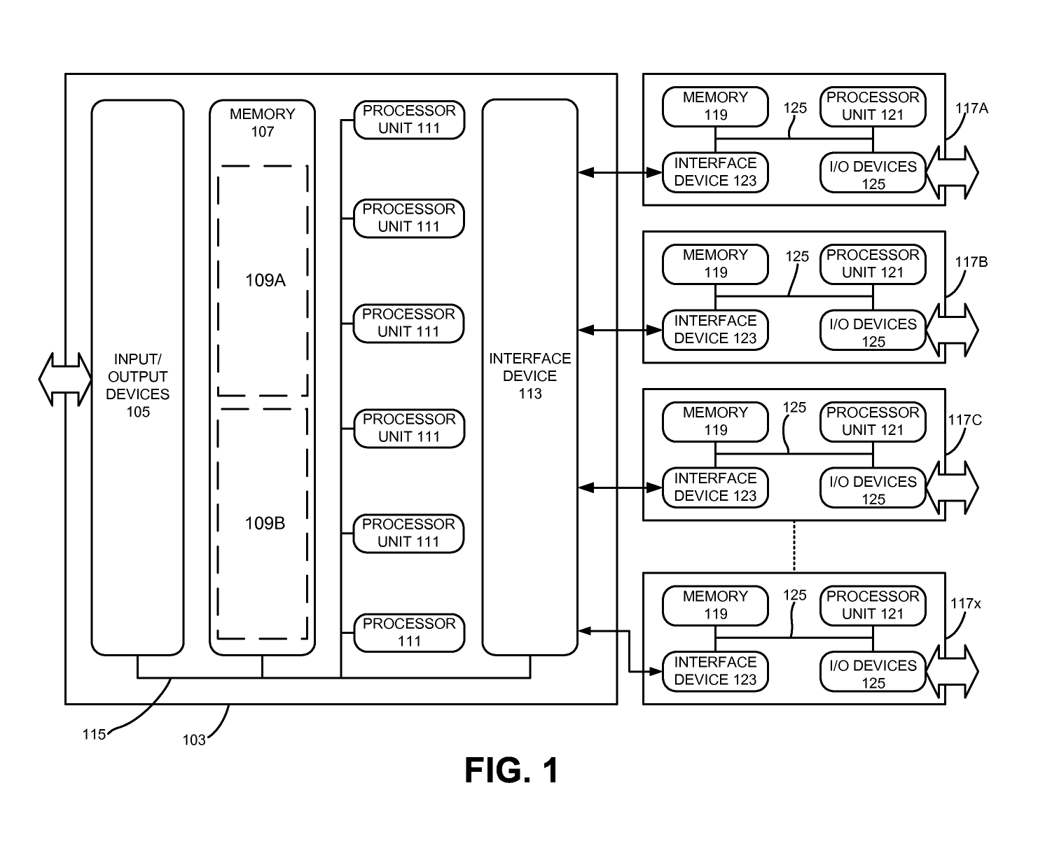

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 101. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

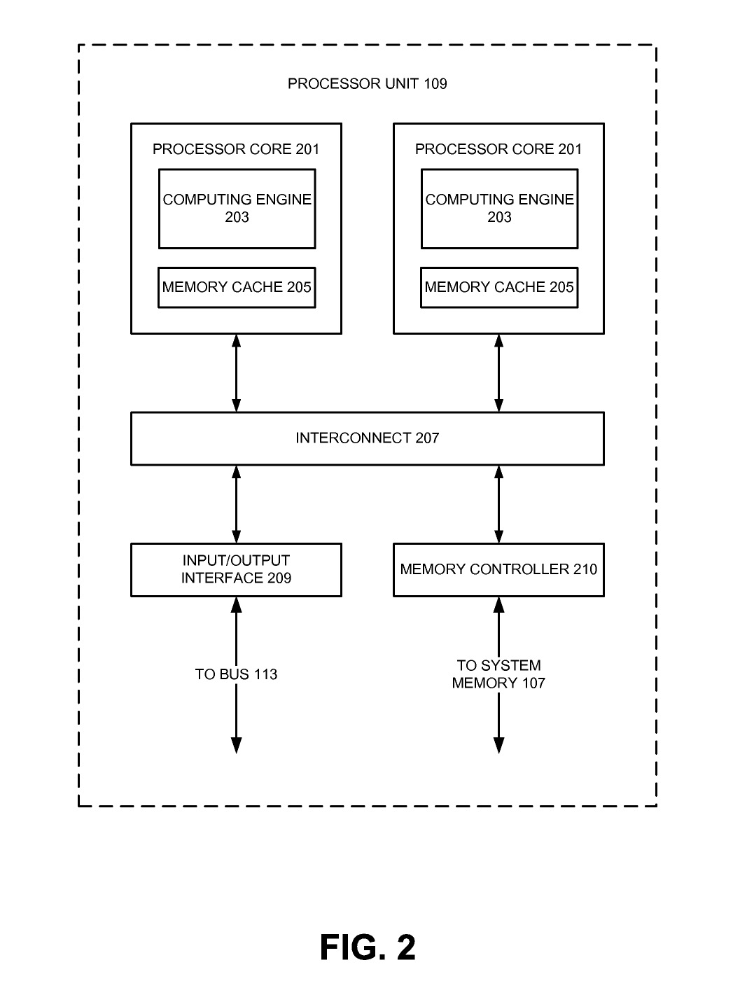

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of the computer readable media discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

### CONCLUSION

While aspects of the invention have been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

1. One or more computer readable media storing computer-executable instructions for causing a computer to perform any of the new and nonobvious methods and method acts described herein, both alone and in combinations and subcombinations with one another.

2. A method of identifying uniform coloring conflicts in layout design data comprising any of the new and nonobvious methods and method acts described herein, both alone and in combinations and subcombinations with one another.

3. One or more computer readable media storing instructions for identifying uniform coloring conflicts in layout design data in accordance with any of the new and nonobvious methods and method acts described herein both alone and in combinations and subcombinations with one another.

4. (canceled)
